(19) United States
(12) Patent Application Publication
(10) Pub. No.: US 2012/0022972 A1
(43) Pub. Date: Jan. 26, 2012

(54) ONLINE SYSTEM, METHOD AND COMPUTER PROGRAM PRODUCT FOR VENDORS TO SHARE PRODUCT AND/OR SERVICE PRICEBOOKS WITH RETAILERS

(76) Inventor: Charlie Hrach Mirzakhanyan, Glendale, CA (US)

(21) Appl. No.: 13/190,570

(22) Filed: Jul. 26, 2011

Related U.S. Application Data
(60) Provisional application No. 61/344,451, filed on Jul. 26, 2010.

(51) Int. Cl. G06Q 30/00

(52) U.S. Cl. 705/26.61

(57) ABSTRACT

A system, method and computer program product for vendors and retailers to share product or service pricebooks, including a server configured to receive a pricebook from a vendor computer, the pricebook specifying products or services offered by the vendor; the server configured to authorize a connection request between the vendor computer and a retailer computer, based on authorization by a user of the vendor computer and a user of the retailer computer; and the server configured to transmit the pricebook to the retailer computer after the connection request between the vendor computer and a retailer computer is authorized.

### CROSS REFERENCE TO RELATED APPLICATIONS

The present invention claims benefit of priority to U.S. Provisional Patent Application Ser. No. 61/344,451 of MIRZAKHANYAN, entitled “ONLINE SYSTEM/WEBSITE WHERE VENDORS SHARE PRODUCT PRICEBOOK WITH RETAILERS,” filed on Jul. 26, 2010, the entire disclosure of which is hereby incorporated by reference herein.

### BACKGROUND OF THE INVENTION

1. Field of the Invention

The present invention generally relates to online business-to-business (B2B) commerce systems and methods, and more particularly to an improved pricebook sharing system and method for vendors to share product and/or service pricebooks, and the like, with retailers.

2. Discussion of the Background

In recent years, various business-to-business (B2B) systems and methods have been deployed. However, such systems and methods do not always connect vendors and retailers in a mutually beneficial manner. Accordingly, there is a need for improved systems and methods for connecting vendors and retailers in reliable, cost effective, and mutually beneficial manner, as compared to conventional systems and methods.

### SUMMARY OF THE INVENTION

Therefore, there is a need improved methods and systems for connecting vendors and retailers that address the above and other problems with conventional systems and methods. The above and other needs are addressed by the exemplary embodiments of the present invention, which provide an improved system and method for vendors to share product and/or service pricebooks, and the like, with retailers and manage connections between vendors and retailers in reliable, cost effective, and mutually beneficial manner.

Accordingly, in exemplary aspects of the present invention, there are provided a system, method and computer program product for vendors and retailers to share product or service pricebooks, including a server configured to receive a pricebook from a vendor computer, the pricebook specifying products or services offered by the vendor; the server configured to authorize a connection request between the vendor computer and a retailer computer, based on authorization by a user of the vendor computer and a user of the retailer computer; and the server configured to transmit the pricebook to the retailer computer after the connection request between the vendor computer and a retailer computer is authorized.

The server can be configured to receive information regarding the vendor from the user of the vendor computer.

The server can be configured to receive information regarding the retailer from the user of the retailer computer.

The information regarding the vendor can include the pricebook and information regarding the company of the vendor.

The information regarding the retailer can include information regarding the company of the retailer.

The server can be configured to mange connection requests for the vendors and the retailers.

Advantageously, with the online system, method and computer program product for vendors to share product and/or service pricebooks with retailers, vendors and retailers can be connected with each other in a mutually beneficial manner.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary online system for vendors to share product and/or service pricebooks with retailers, according to an exemplary embodiment; and

FIGS. 2A-2D illustrate an exemplary online method for vendors to share product and/or service pricebooks with retailers corresponding to the system of FIG. 1, according to an exemplary embodiment.

### DETAILED DESCRIPTION OF THE PREFERRED EMBODIMENTS

An improved online system and method for vendors to share product and/or service pricebooks with retailers is described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

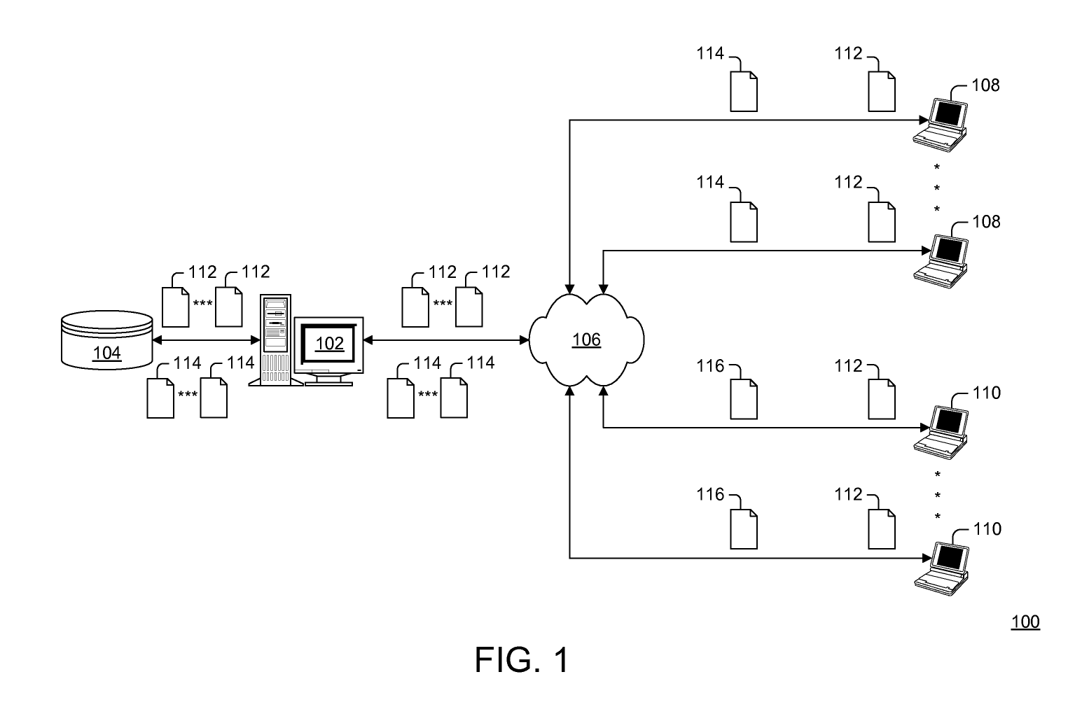

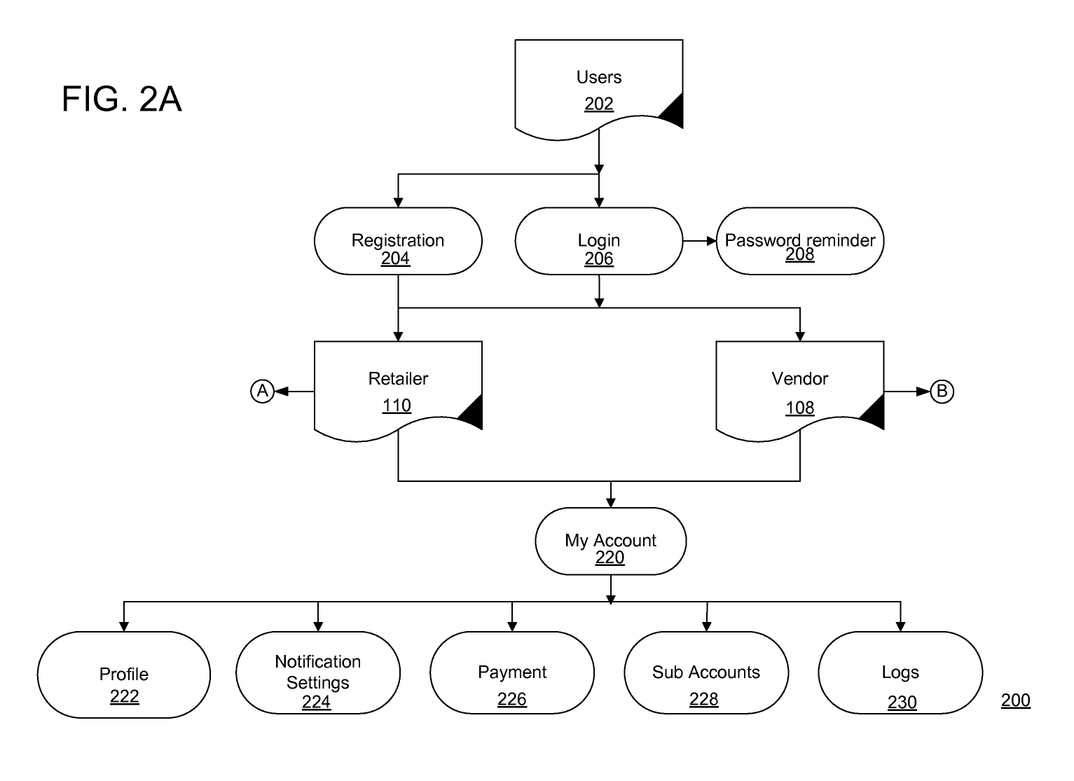

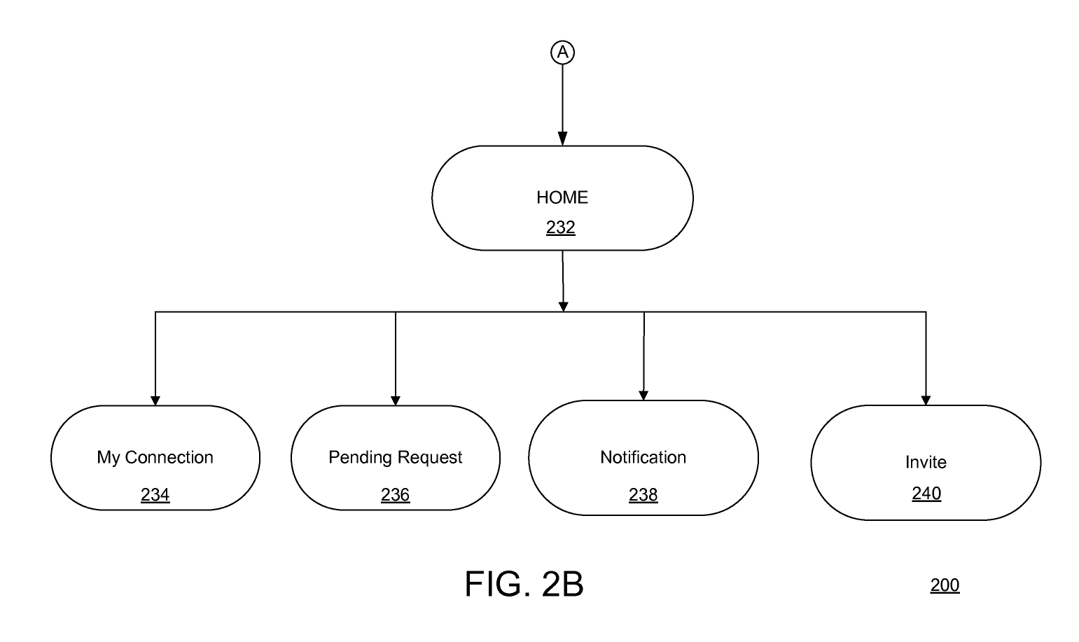

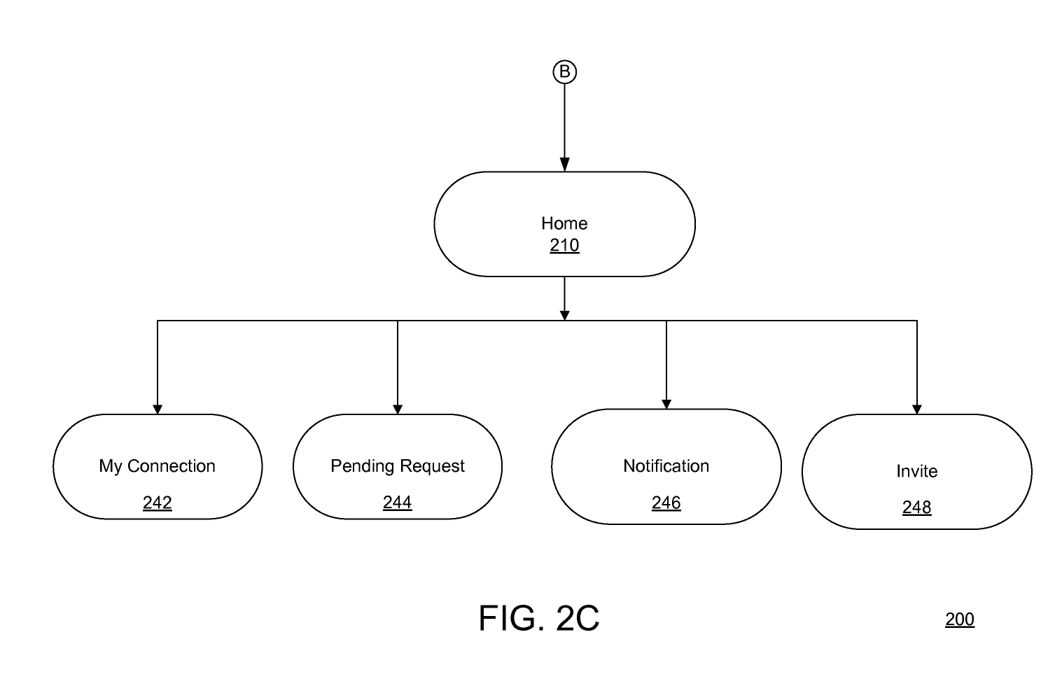

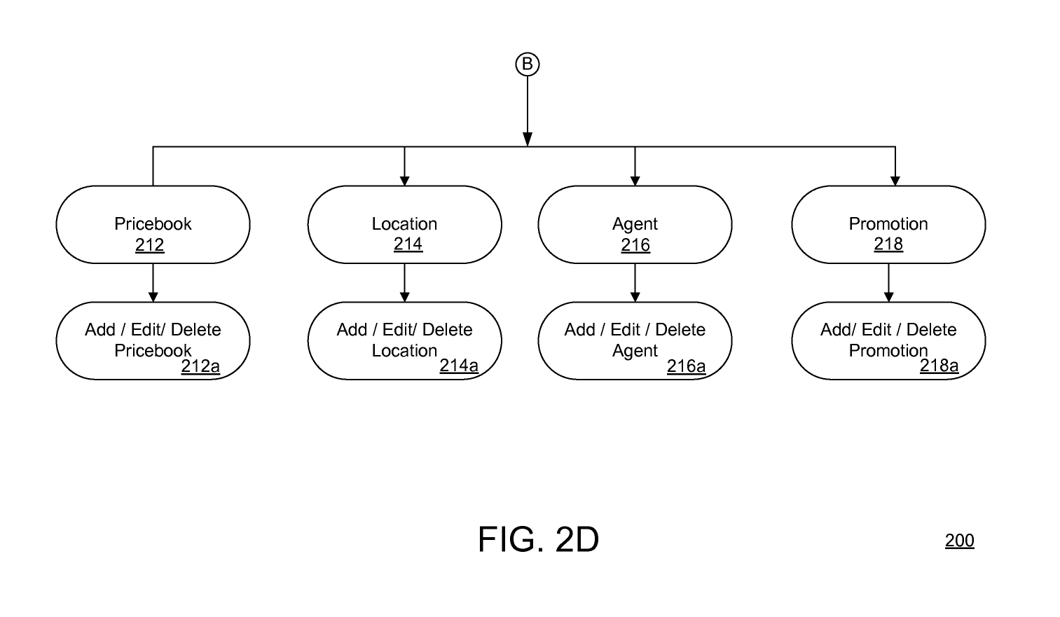

Referring now to the drawings, FIGS. 1-2 thereof illustrates an exemplary online system and method for vendors to share product and/or service pricebooks with retailers, according to an exemplary embodiment. In FIGS. 1-2, the exemplary system 100 and method 200 can include a server 102 and database 104 coupled to one or more vendor computer systems 108 and retailer computer systems 110 over a communications network 106 (e.g., the Internet, a LAN, a WAN, etc.).

Generally, the exemplary system 100 and method 200 allows for the vendors 108 to share product and/or service pricebooks, pricelists 112, and the like, with the retailers 110. Advantageously, a business-to-business (B2B), web based system 100 and method 200 are provided, which unite users 202, such as the vendors 108 and the retailers 110, via a virtual connection over the communications network 106 and allow the vendors 108 to share their pricelist, pricebooks 112, and the like, with the retailer 110, register as a vendor or retailer via registration step or page 204, login as a vendor or retailer via login step or page 206, and perform password related tasks (e.g., set/reset passwords, send password reminders, etc.) via password step or page 208.

The vendor registration step or page 204 can include creating a company profile, inputting sales agent information, inputting company location(s), uploading prices for products the vendor 108 is selling, adding retail accounts (e.g., for companies that are reselling products, etc.), and the like, to a retailer list 114 of the retailer 110, including assigning the retailer 110 one or more of the pricebooks 112, for example, including agent, location, and the like, information. Similarly, the retailer registration step or page 204 can include creating a company profile, adding vendor accounts (e.g., for companies that the retailer 110 is purchasing products from, etc.) to a vendor list 116, for example, including a vendor identification (ID), and the like, information. After a connection is established (e.g., similar to a “friend” or “connection” request and/or confirmation, etc.) between the retailer 110 and the vendor 108, the retailer 110 can access product pricing, details, pictures, one or more of the pricebooks 112, and the like, for products of the vendor 108, as well as send purchase orders, process payments, and the like.

Accordingly, a user 202 registers as a vendor 108 by completing the registration application page or step 204, which can include the business name, company URL, user's full name, business address, phone number, fax number, email, type of business, type of product the company is selling, and the like. In step 204, the system 100 and method 200 send a registration verification email to the user's email, the user certifies the request for registration by clicking on a link in the email, the system 100 and method 200 approve and send account registration approval email to the user's email, and the system 100 and method 200 send a login page link to the user's email. The user can click on the link in the email and the system 100 and method 200 direct the user to the login page or the user can simply log into the system 100 by visiting a suitable URL on the worldwide web (e.g., websitename.com). From the login page, the user enters their user name and password to login into their account. Once the user is logged into their account, the user can enter and upload the information 114, and the like, about the company of the vendor 108.

The vendor 108 account or web page 220 can include various main tabs/pages, for example, Home 210, Pricebooks 212, Locations 214, Agents 216, Promotions 218, My Account 220, Login 206, and the like, all with respective add/edit/delete functionality 212a-218a. The Pricebook tab or page 212 can allow the vendor 108 to upload/submit pricebooks 112 into the system 100. Each pricebook 112 can include a plurality of product prices and detailed information, including pictures, and the like. The system 100 and method 200 can generate folders, and the like, for each pricebook 112 being uploaded. The folders can be assigned to authorized retailers 110 (e.g., based on approved connection/friend requests, etc.). Advantageously, the vendor 108 via the system 100 and method 200 can view pricebooks 112 that have already been submitted, can add/edit/delete already uploaded/submitted pricebooks 112, products, information, and the like, can upload pictures of the product, and the like.

The Locations tab or page can be used by the vendor 108 to enter the company's distribution center's addresses, phone numbers, fax numbers, email addresses, hours of operations, and the like. The system 100 and method 200 can create a folder for every location added, and the like, and the folders can be assigned to authorized retailers 110 (e.g., approved connections, etc.).

The Agents tab or page 216 can be used by the vendor 108 to manage the company's Sales Representatives or agents as well as other information pertaining to assigned retailer 110 accounts, and the like. For example, the vendor 108 can enter sales agent's full name, email address, phone/fax numbers, and the like. The system 100 and method 200 can create a folder for every agent that is entered into the system 100 and the folders can be assigned to authorized retailers 110 (e.g., approved connections, etc.).

The Promotions tab or page 218 allows the vendor 108 to create company newsletters, promotional flyers, and the like, and upload the created information into the system 100, wherein the system 100 and method 200 can send a link corresponding created promotions to the assigned retailers 110. Advantageously, the vendor 108 can view, add, edit, delete, upload/submit, and the like, new promotions, and the like.

The My Account tab or page 220 can provide the user 202 (e.g., the vendors 108 and the retailers 110, etc.) access to various pages or tabs, for example, including Profile 222, Notification Settings 224, Payments 226, Subaccount Settings 228, Logs 230, and the like. The Profile tab or page 222 can be used by the user 202 to change company information, such as phone/fax numbers, email address, user name, password, administrative contact information, a custom URL identification (ID), such as a custom URL on the worldwide web (e.g., websitename.com/CompanyName), and the like.

The Notification tab or page 224 can be used by the user 202 to control what types of notifications to receive in an email, text message, other communication methods, and the like. The system 100 and method 200 saves such settings and sends the corresponding notification (e.g., requests to add a contact, add request denials, etc.).

The Payments tab or page 226 allows the user 202 to update payment methods, edit payment plans, view invoices, change membership plans, and the like. The Sub Accounts tab or page 228 allows the user 202 to create subaccounts for company staff to login, and the like. The user 202 can add, delete, edit, archive, and the like the created subaccounts. Advantageously, the system 100 and method 200 allow the user 202 to create login sub accounts for staff, including assigning limited access, and the like, to such subaccounts. The Logs tab or page 230 allows the user 202 to monitor login activities of for the company profile, view histories, access archives, restore accounts, and the like.

The Home tab or page 210 of the vendor 108 (also referred to as a “vendor page”) can include a plurality pages or tabs, functionalities, and the like. For example, via the My Connections tab or page 242, the system 100 and method 200 combines all approved accounts (e.g., already connected to contacts, etc.) into the page or tab 242. From the My Connections tab or page 242, the vendor 108 can view and access company profiles, name, phone number, emails, address, contact person(s), assigned agent's name, agent phone number, assigned location, and the like, of the retailers 110. The vendor 108 can add, delete, remove, edit, and the like, the retailers 110. For example, by clicking on a company name or retailer 110 (e.g., via a link, etc.) and/or an “Edit” button, the system 100 and method 200 direct the vendor 108 via the link to the corresponding profile of the retailer 110. Advantageously, clicking the “Edit” button allows the vendor 108 to assign a new pricebook 112, change the assigned pricebooks 112, assign a new agent, new location, send an email to the retailer 110, and the like.

The Pending Requests tab or page 244 displays pending connection requests that are sent from the vendor 108 to the retailer 110 for approval, pending connection requests that are sent from the retailer 110 to the vendor 108 for approval, and the like. Connection requests are maintained in the Pending Requests tab or page 224 until the corresponding connection gets approved, discarded, and the like, by one of the parties (e.g., the vendor 108 or the retailer 110, etc.).

The Notification tab of page 246 displays all the activity on the notification page (e.g., that the retailer 110 has accepted a pending request connection, that the retailer 110 has discarded a connection, etc.). The Invite tab or page 248 allows the vendor 108 to send to an email of the retailer 110 an invitation or request to the retailer 110 to connect as a retailer with the vendor 108 (e.g., on a suitable URL on the worldwide web, such as websitename.com, etc.). The system 100 and method 200 can send an “approve” or “ignore” link to a corresponding email of the retailer 110 and if the retailer 110 clicks “approve,” the system 100 and method 200 create a connection between both parties. The system 100 and method 200 can also send the request to the Pending Request tab or page 244, as needed.

Additional functionalities are provided by the system 100 and method 200 to the vendors 108 (and/or the retailers 110), and can include a “New Connections” search box, wherein the system 100 and method 200 allows the user 202 to search the database 104 for other registered users and send requests to add them as retailers 110, and the like. A “Product search” search box can be provided, wherein the system 100 and method 200 allows the user 202 to search the database 104 for products within submitted pricebooks 112, for example, by entering a product name, item code, a description that describes the product, and the like. A “My Connections” search box can be provided, wherein the system 100 and method 200 allows the user 202 to search for a connection within existing connections of the user 202. For example, the user 202 can search by company name, phone number, agent name, and the like.

Similarly, a user 202 can register as a retailer 110 by completing the registration application page or step 204, which can include business name, company URL, user's full name, business address, phone number, fax number, email, type of business, type of product the company is selling, and the like. In step 204, the system 100 and method 200 send a registration verification email to the user's email, the user certifies the request for registration by clicking on a link in the email, the system 100 and method 200 approve and send account registration approval email to the user's email, and the system 100 and method 200 send a login page link to the user's email. The user can click on the link in the email and the system 100 and method 200 direct the user to the login page or the user can simply log into the system 100 by visiting a suitable URL on the worldwide web (e.g., websitename.com). From the login page, the user enters their user name and password to login into their account. Once the user is logged into their account, the user can enter and upload the information 116, and the like, about the company of the retailer 110.

The account of the retailer 110 includes similar tabs, pages and/or functionality as the account of the vendor 108, as previously described, including the My Account 220, Profile 222, Notification 224, Payment 226, Sub Accounts 228, Logs 230, and the like, tabs or pages, sign in and out functionalities, and the like, and which description are omitted here for the sake of brevity.

Accordingly, a Home tab or page 232 of the retailer 110 (also referred to as a “retailer page”) can include a plurality pages or tabs, functionalities, and the like. For example, via the My Connections tab or page 234, the system 100 and method 200 combines all approved (e.g., existing connections, etc.) vendor 108 accounts into the page 234. From the page 234, the retailer 110 can view and has access to company profiles, names, phone/fax numbers, email addresses, company addresses, contact person(s), assigned agent's names, agent contact info, assigned locations, and the like, of the vendors 108. The retailer 110 can add, delete, remove, edit, and the like, the vendors 108. For example, by clicking on a company name or vendor 108 (e.g., via a link, etc.), the system 100 and method 200 direct the retailer 110 via the link to the corresponding profile of the vendor 108, wherein the retailer 110 can have access to the pricelists 112 of the vendors 108 and can search for product pricing, via a product search box, and the like. The retailer 108 also can view the company information, contact person(s) information, assigned agent's information, as well as assigned pricebook(s) 112, and the like, of the corresponding vendors 108. Advantageously, clicking an “Edit” button allows the retailer 110 to assign vendor identification (ID) numbers, add, edit and/or delete notes and vendors 108 and the like.

Similarly, the Pending Requests tab or page 236 displays pending connection requests that are sent from the vendor 108 to the retailer 110 for approval, pending connection requests that are sent from the retailer 110 to the vendor 108 for approval, and the like. Connection requests are maintained in the Pending Requests tab or page 224 until the corresponding connection gets approved, discarded, and the like, by one of the parties (e.g., the vendor 108 or the retailer 110, etc.).

The Notification tab or page 238 of the retailer 110 sends a suitable notification to the Notification tab or page 246 of the retailer 110, for example, when the vendor 108 updates the assigned pricebook 112, assigns new sales agent, updates sales agent's information, updates the assigned location, assigns a new location, submits a promotion, changes a discount structure, approves an add request, discards an add request, removes the retailer 110 as a contact, and the like.

Similarly, the Invite tab or page 240 allows the retailer 110 to send to an email of a vendor 108 an invitation or request to the vendor 108 to connect as a vendor with the retailer 110 (e.g., on a suitable URL on the worldwide web, such as websitename.com, etc.). The system 100 and method 200 can send an “approve” or “ignore” link to a corresponding email of the vendor 108 and if the vendor 108 clicks “approve,” the system 100 and method 200 create a connection between both parties. The system 100 and method 200 can also send the request to the Pending Request tab or page 236, as needed.

Similarly, additional functionalities are provided by the system 100 and method 200 to the retailers 110 (and/or the vendors 108), and can include a “New Connections” search box, wherein the system 100 and method 200 allows the user 202 to search the database 104 for other registered users and send requests to add them as retailers 110, and the like.

A “Product search” search box can be provided, including Vendor ID and Product Name sections, wherein the system 100 and method 200 allows the user 102 to search product pricing by typing in an assigned Vendor ID in the Vendor ID section, and a product name in the Product name section. Products can also be searched for by item code, bar code, other description, and the like, that correspond to or describe a specific product. The system 100 and method 200 receives the submitted search information and searches within the assigned pricebooks 112 of the corresponding vendor 108. Advantageously, the system 100 and method 200 allows the retailer 110 to search for a product within assigned pricebooks 112 of their vendor 108 connections. Similarly, a “My Connections” search box can be provided, wherein the system 100 and method 200 allows the user 202 to search for a connection within existing connections of the user 202. For example, the user 202 can search by company name, phone number, agent name, and the like.

The above-described devices and subsystems of the exemplary embodiments can be accessed by or included in, for example, any suitable servers, clients, workstations, PCs, laptop computers, PDAs, Internet appliances, handheld devices, cellular telephones, wireless devices, other devices, and the like, capable of performing, accessing or employing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like

It is to be understood that the devices and subsystems of the exemplary embodiments are for exemplary purposes, as many variations of hardware and/or software used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What is claimed is:

1. A system for vendors and retailers to share product or service pricebooks, the system comprising:
a server configured to receive a pricebook from a vendor computer, the pricebook specifying products or services offered by the vendor;
the server configured to authorize a connection request between the vendor computer and a retailer computer, based on authorization by a user of the vendor computer and a user of the retailer computer; and
the server configured to transmit the pricebook to the retailer computer after the connection request between the vendor computer and a retailer computer is authorized.

2. The system of claim 1, wherein the server is configured to receive information regarding the vendor from the user of the vendor computer.

3. The system of claim 1, wherein the server is configured to receive information regarding the retailer from the user of the retailer computer.

4. The system of claim 2, wherein the information regarding the vendor includes the pricebook and information regarding the company of the vendor.

5. The system of claim 3, wherein the information regarding the retailer includes information regarding the company of the retailer.

6. The system of claim 1, wherein the server is configured to manage connection requests for the vendors and the retailers.

7. A computer implemented method for vendors and retailers to share product or service pricebooks, the method comprising:
receiving by a server a pricebook from a vendor computer, the pricebook specifying products or services offered by the vendor;
authorizing by the server a connection request between the vendor computer and a retailer computer, based on authorization by a user of the vendor computer and a user of the retailer computer; and
transmit by the server the pricebook to the retailer computer after the connection request between the vendor computer and a retailer computer is authorized.

8. The method of claim 7, wherein the server is configured to receive information regarding the vendor from the user of the vendor computer.

9. The method of claim 7, wherein the server is configured to receive information regarding the retailer from the user of the retailer computer.

10. The method of claim 8, wherein the information regarding the vendor includes the pricebook and information regarding the company of the vendor.

11. The method of claim 9, wherein the information regarding the retailer includes information regarding the company of the retailer.

12. The method of claim 7, wherein the server is configured to manage connection requests for the vendors and the retailers.

13. A computer program product for vendors and retailers to share product or service pricebooks, and including one or more computer readable instructions embedded on a non-transitory computer readable medium and configured to cause one or more computer processors to perform the steps of:
receiving by a server a pricebook from a vendor computer, the pricebook specifying products or services offered by the vendor;
authorizing by the server a connection request between the vendor computer and a retailer computer, based on authorization by a user of the vendor computer and a user of the retailer computer; and
transmit by the server the pricebook to the retailer computer after the connection request between the vendor computer and a retailer computer is authorized.

14. The computer program product of claim 13, wherein the server is configured to receive information regarding the vendor from the user of the vendor computer.

15. The computer program product of claim 13, wherein the server is configured to receive information regarding the retailer from the user of the retailer computer.

16. The computer program product of claim 14, wherein the information regarding the vendor includes the pricebook and information regarding the company of the vendor.

17. The computer program product of claim 14, wherein the information regarding the retailer includes information regarding the company of the retailer.

18. The computer program product of claim 13, wherein the server is configured to manage connection requests for the vendors and the retailers.
